(19) United States
(12) Patent Application Publication
(10) Pub. No.: US 2007/0186713 A1
(43) Pub. Date: Aug. 16, 2007

(54) Transforming Limb

(76) Inventor: Michael Trzecieski, Hong Kong (HK)

Correspondence Address: Michael Trzecieski, Flat A, 1F Caineway Mansion, 130 Caine Rd., Mid Levels, HK

(21) Appl. No.: 11/673,579

(22) Filed: Feb. 11, 2007

Related U.S. Application Data
(60) Provisional application No. 60/766,795, filed on Feb. 12, 2006.

(51) Int. Cl. B25J 18/00

(52) U.S. Cl. 74/490.01

(57) ABSTRACT

A novel transforming limb is disclosed for transforming from a first position to a second position for facilitating legged or wheeled operation. Transformation between the first and second positions is preferably facilitated using powered actuators.

This application claims priority from U.S. Provisional Application No. 60/766,795 Filed on Feb. 12, 2006.

### FIELD OF THE INVENTION

The invention relates to the field of transforming robotic devices and more specifically to the field of a transforming robotic device that facilitates a dual form of locomotion.

### BACKGROUND OF THE INVENTION

Transportation over terrain for robotic platforms is important in a varying environment. In some cases it is advantageous to travel by wheeled motion, in other cases it is advantageous to travel by using legged motion. More specifically in using bipedal motion. In some cases it is advantageous to utilize both wheeled and legged motion and to perform transformation between the two in dependence upon the terrain.

It is therefore an object of the present invention to provide a transforming limb for transforming from an approximately closed shape having an approximately continuous outer surface to an extended shape.

### SUMMARY OF THE INVENTION

In accordance with the invention there is provided a device comprising: a first member that is rotationally coupled to a second member that is rotationally coupled to a third member that is rotationally coupled to a fourth member in series, where in a first position of the device the four members form an approximately closed shape having an approximately continuous outer surface and an inner surface of each member facing an inner surface of at least one other member from the four members, and where in a second position of the device the inside surface of at least one of the four members is for forming contact with an object and the four members form an approximately other than closed shape having the approximately continuous outer surface.

In accordance with the invention there is provided a method comprising: providing a device comprising: a first member that is rotationally coupled to a second member that is rotationally coupled to a third member that is rotationally coupled to a fourth member in series, where in a first position of the device the four members form an approximately closed shape having an approximately continuous outer surface and an inner surface of each member facing an inner surface of at least one other member from the four members, and where in a second position of the device the inside surface of at least one of the four members is for forming contact with an object and the four members form an approximately other than closed shape having the approximately continuous outer surface; rotating the fourth member with respect to the third member; rotating the third member with respect to the second member; rotating the second member with respect to the first member; and, contacting a surface with the fourth member.

### BRIEF DESCRIPTION OF THE DRAWINGS

Exemplary embodiments of the invention will now be described in conjunction with the following drawings, in which:

FIGS. 1a through 1f illustrate a transforming limb, where the transformation from a first position is shown through the figures as the device transforms from a first position (FIG. 1a) to a second position (FIG. 1f);

FIGS. 2a through 2d illustrate the transforming limb in the first position from a top, front, side and perspective views, respectively;

FIGS. 2e and 2f illustrate the transforming limb in the second position, where FIG. 2e illustrates the device from a font view and FIG. 2f illustrates the device from a rear perspective view;

FIGS. 3a through 3f illustrate various perspective views of the transforming limb in the second position; and

FIGS. 4a and 4b illustrate the transforming limb for being used as forming limbs of a robot.

### DETAILED DESCRIPTION OF EMBODIMENTS OF THE INVENTION

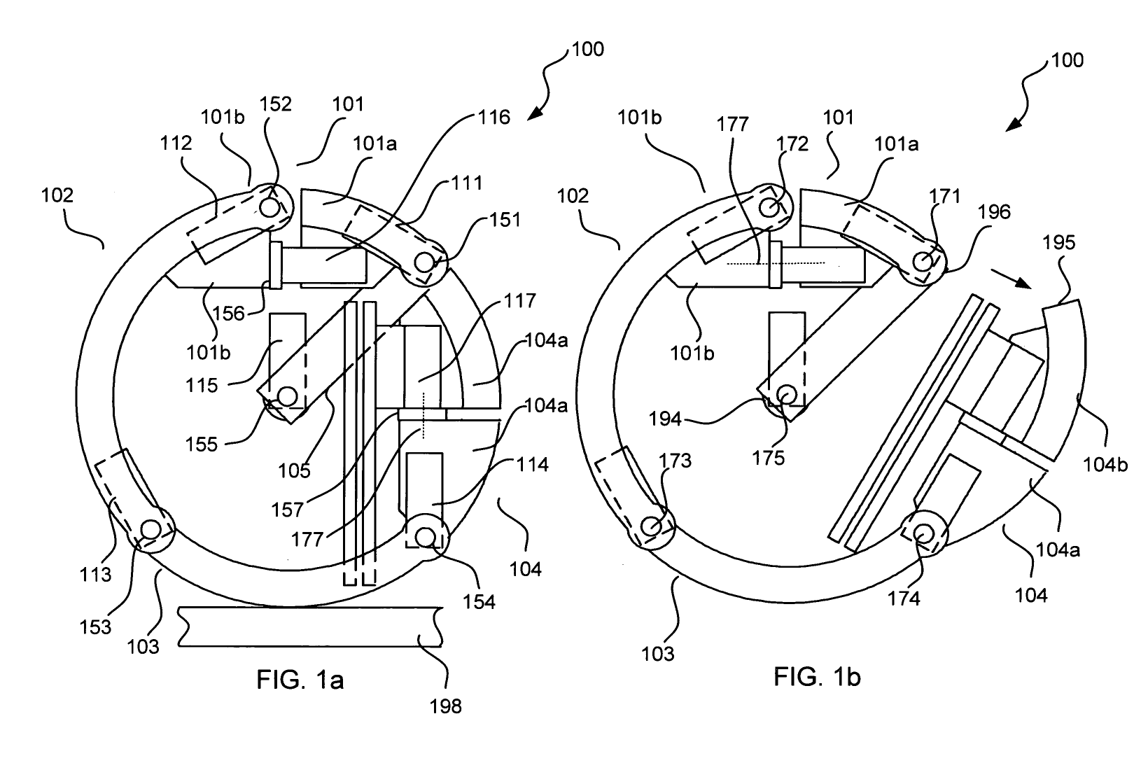

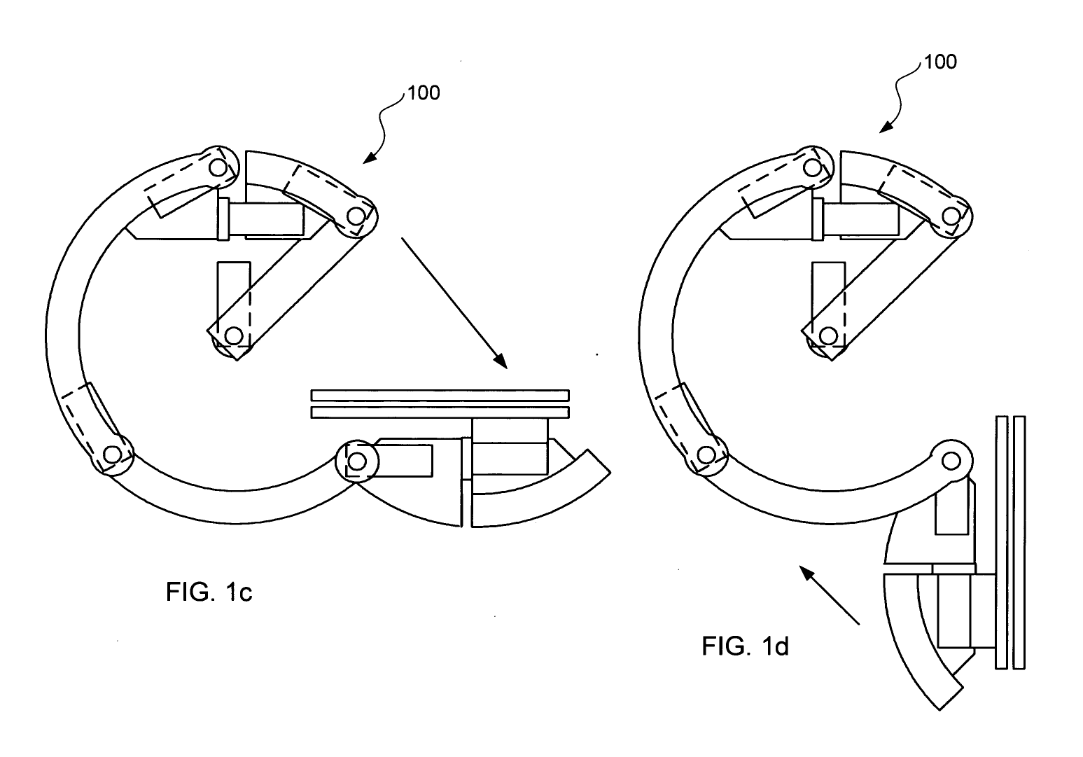

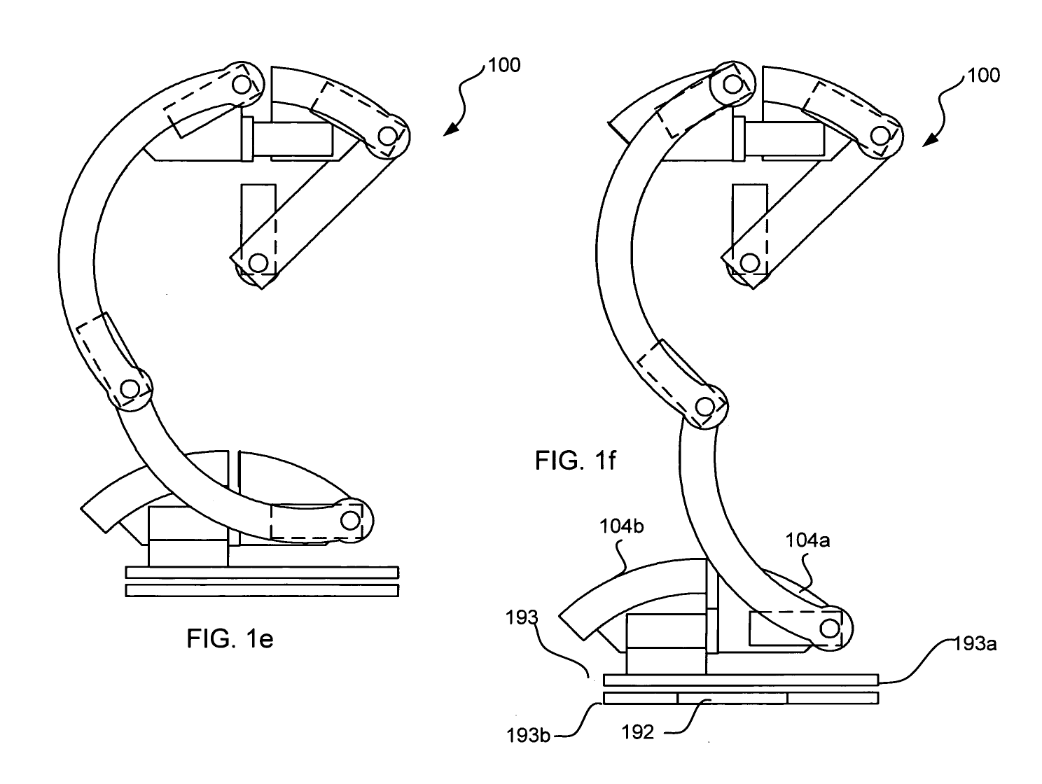

FIGS. 1a through 1f illustrate a transforming limb 100 that transforms between a first position, as shown in FIG. 1a, to a second position, as shown in FIG. 1f. Referring back to FIGS. 1a and 1b, the a transforming limb 100 comprises: a first member 101 rotationally coupled to a second member 102 that is rotationally coupled to a third member 103 that is rotationally coupled to a fourth member 104 in series, where in a first position of the a transforming limb, as shown in FIG. 1a, the four members form an approximately closed shape with each having an approximately continuous outer surface and an inner surface facing an inner surface of at least one other member from the four members.

The first member 101 comprises a first rotational coupling 181 disposed proximate a first end thereof 101aa; the second member 102 comprises a second rotational coupling 182 disposed proximate a first end thereof 102aa and rotationally coupled with the first member 101 proximate a second end 102bb thereof for rotating of the second member 102 with respect to the first member 101 about a second axis 172; the third member 103 comprises a third rotational coupling 183 disposed proximate a first end thereof 103aa and rotationally coupled with the second member 102 proximate a second end thereof 102bb for rotating of the third member 103 with respect to the first member 101 about a third axis 173; and the fourth member 104 comprises a fourth rotational coupling 184 disposed proximate a first end 104aa thereof and rotationally coupled with the third member 103 proximate a second end thereof 103bb for rotating of the fourth member 104 with respect to the third member 103 about a fourth axis 174. In a second position of the transforming limb 100 the inside surface of at least one of the four members 101 102 103 104 is for forming contact with an object 198 and the four members form an approximately other than closed shape having the approximately continuous outer surface.

A fifth member 105 is rotationally coupled at a first end 105aa thereof with the first rotational coupling 181 for rotating with respect to the first member 101 about the first axis 171 and having a fifth rotational coupling 185 disposed proximate a second end thereof 105bb for rotating of the fifth member 105 about the fifth axis 175.

Optionally the fifth member is rotationally coupled at the first end thereof with the second rotational coupling for rotating with respect to the first member about the second axis and having the fifth rotational coupling 185 disposed proximate a second end thereof 105bb for rotating of the fifth member 105 about the fifth axis 185.

Preferably the a transforming limb 100 comprises at least an actuator disposed within at least one of the first through fifth rotational couplings for controllable actuating of the rotation between the first through fifth members. For example, actuators 151 through 157 are utilized for actuating rotational couplings 181 through 187. Preferably a hub 150 comprises the fifth rotary actuator 155 for in the first position of the transforming limb (FIG. 1a) for controllably rotating of the first through fifth members about the fifth axis 175, where the approximately continuous outer surface is for forming an approximately elliptical shape for contacting the object 198 using a rolling motion. Preferably this rolling motion is actuated using the fifth rotary actuator 155. A rotational electrical and control signal coupling 194 is preferably disposed between the hub 150 and the fifth member 105 for providing of electricity to the actuators and for the control signal for controllable actuation of the first, second, third, fourth, sixth and seventh actuators, 151, 152, 153, 156, 157, respectively.

Preferably the transforming limb 100 comprises a groove assembly 196 disposed proximate the first end 101aa of the first member 101 and a tongue assembly 195 disposed about the second end 104bb of the fourth member 104 for contacting the groove assembly when the transforming limb is in the first position.

Preferably, the first member 101 comprises: a first portion 101a comprising the first end 101aa of the first member, a second portion 101b comprising the second end 101bb of the first member 101, a sixth rotary coupling 186 disposed between the first portion 101a and the second portion 101b of the first member 101, the sixth rotational coupling 186 for rotating of the first portion 101a with respect to the second portion 101b of the first member 101 about a sixth axis 176.

Preferably, the fourth member comprises: a first portion 104a comprising the first end 104aa of the fourth member 104, a second portion 104b comprising the second end 104bb of the fourth member 104, a seventh rotary coupling 187 disposed between the first portion 104a and the second portion 104b of the fourth member 104, the seventh rotational coupling 187 for rotating of the first portion 104a with respect to the second portion 104b of the fourth member 104 about the seventh axis 177.

Preferably within the transforming limb 100 an angle formed between the sixth axis 176 and the second axis 172 is approximately 90 degrees. Preferably an angle formed between the seventh axis 177 and the fourth axis 174 is approximately 90 degrees.

Referring to FIG. 1f, a foot 193 is preferably coupled with the second portion 104b of the fourth member 104. Preferably the foot 193 extends from the second end 104bb of the fourth member 104 towards the first end 104aa of the fourth member 104 past the seventh rotary coupling 187 disposed therebetween. Preferably the foot 193 comprises a first portion 193a coupled with the second portion 104b of the fourth member 104 and a second portion 193b, wherein the second portion 193b is for varying its separation with respect to the first portion 193a in dependence upon an external force applied thereto.

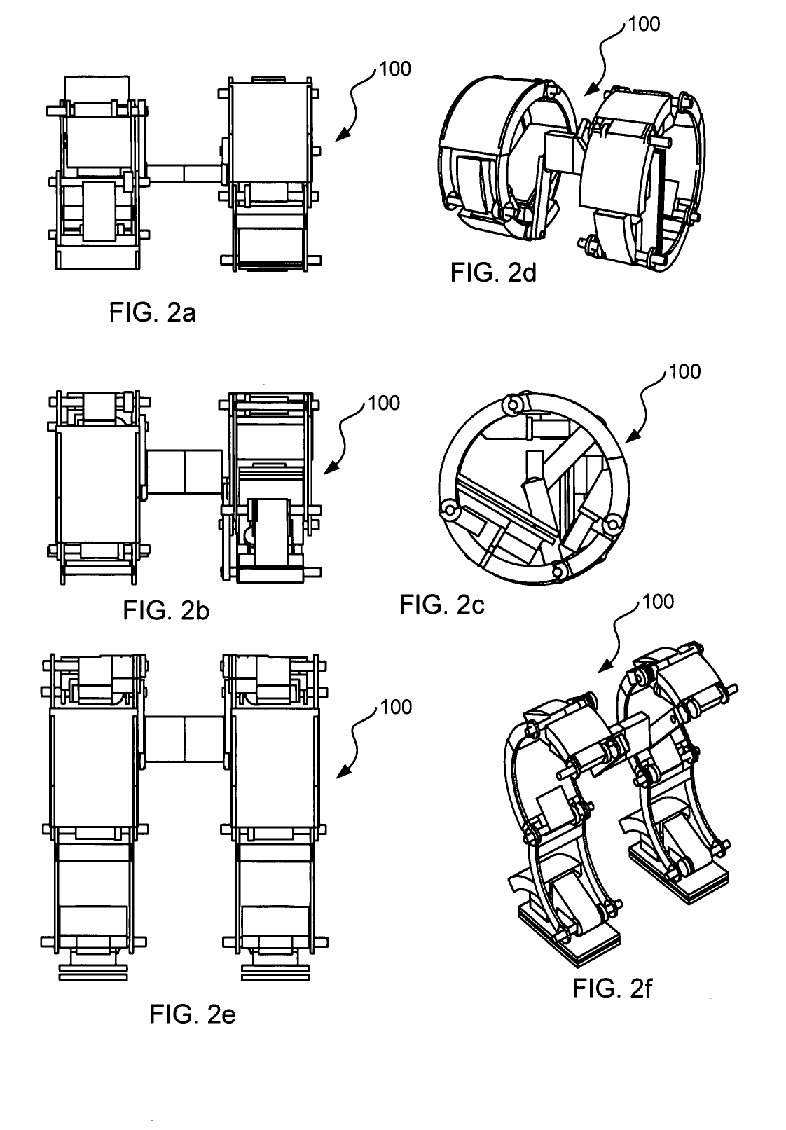

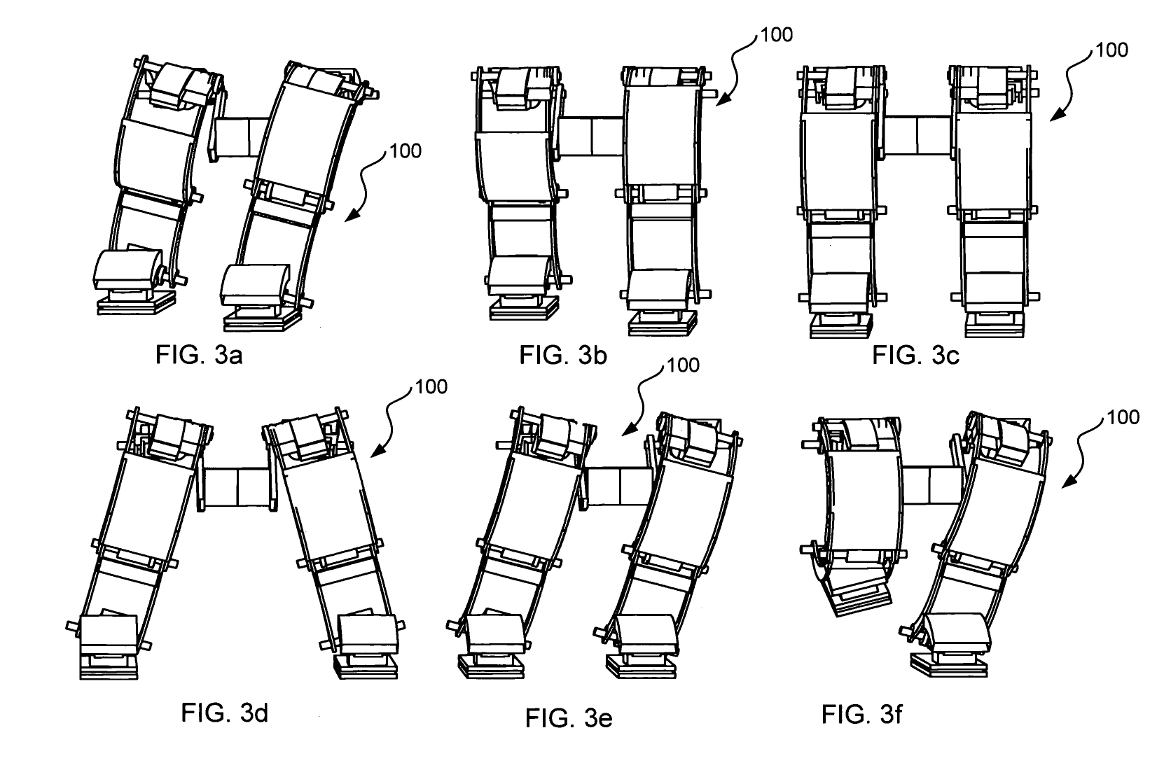

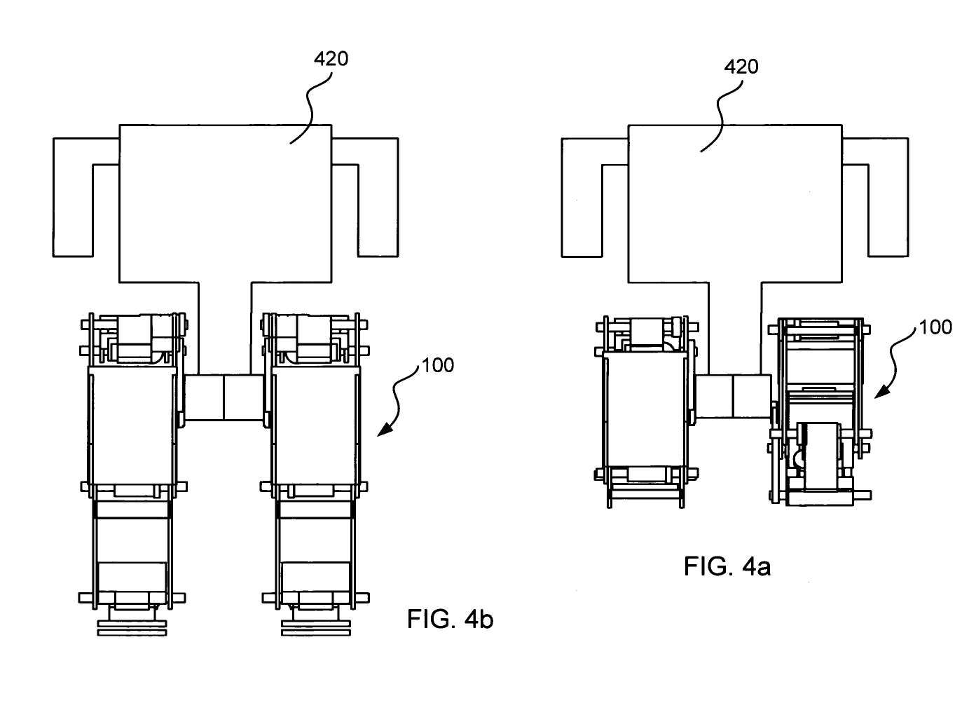

FIGS. 2a through 2d illustrate the transforming limb 100 in the first position from a top, front, side and perspective views, respectively. FIGS. 2e and 2f illustrate the transforming limb 100 in the second position, where FIG. 2e illustrates the transforming limb 100 from a font view and FIG. 2f illustrates the transforming limb from a rear perspective view. FIGS. 3a through 3f illustrate various perspective views of the transforming limb 100 in the second position, where in this second position, the transforming limb facilitates legged motion along with a control circuit for controlling the rotational couplings. Referring to FIGS. 4a and 4b, preferably a control circuit is provided that includes at least an accelerometer and an optional gyroscope for facilitating balancing on two transforming limbs that provide an approximately cylindrical outer surface that resembles two wheels. A body 420 is provided above two transforming limbs 100 for facilitating balancing motion of the body 420 when the transforming limb is operated in the first position.

The transforming limb 100 does not of course necessitate powered actuators but in some cases the rotational couplings are equipped with a ratchet mechanism that facilitates posing of the respectively coupled members about their common rotationally coupled axis.

Of course with such an embodiment as envisaged in FIGS. 1a through 1f, the weight distribution in the transforming limb 100 in the first position is non ideal for preferential rotary motion as the weight imbalance potentially results in non uniform rotary motion of the transforming limb 100 in the first position during the rotary motion. Of course, when using an actuator for actuating of the fifth rotary coupling, the weight imbalance is optionally recorded during operation and a look up table or other form of a functional drive current is applied to the actuator in order to vary the speed and torque delivered thereby such that it results in the approximately closed shape that is formed to roll along the surface 198 in an more uniform fashion.

Furthermore, other embodiments of the transforming limb 100 are envisaged, where timing belts or chains and pulleys or sprockets are coupled between the actuator and the respective rotary coupling for facilitating disposing of the actuator in such a position about the approximately continuous outer surface of the shape. As a result, when the transforming limb in the first position is used in a rolling motion then the redistribution of weight as aforementioned facilitates improved rolling motion of the transforming limb 100.

Optionally, the foot comprises an optical sensor 192 for use in sensing velocity and direction in two approximately orthogonal axes for determining speed and slippage of the foot when the transforming limb 100 is used in a bipedal arrangement for moving forward and backward in the second position.

Optionally, three members are used instead of four members for making of the transforming limb, however with less members, there are less degrees of freedom and as such performance in the first position and second position is potentially compromised.

Numerous other embodiments may be envisaged without departing from the spirit or scope of the invention.

What is claimed is:

1. A transforming limb comprising:
a first member that is rotationally coupled to a second member that is rotationally coupled to a third member that is rotationally coupled to a fourth member in series, where in a first position of the transforming limb the four members form an approximately closed shape having an approximately continuous outer surface and an inner surface of each member facing an inner surface of at least one other member from the four members, and where in a second position of the transforming limb the inside surface of at least one of the four members is for forming contact with an object and the four members form an approximately other than closed shape having the approximately continuous outer surface.

2. A transforming limb according to claim 1 wherein the first member comprises a first rotational coupling disposed proximate a first end thereof; the second member comprises a second rotational coupling disposed proximate a first end thereof and rotationally coupled with the first member proximate a second end thereof for rotating of the second member with respect to the first member about a second axis; the third member comprises a third rotational coupling disposed proximate a first end thereof and rotationally coupled with the second member proximate a second end thereof for rotating of the third member with respect to the first member about a third axis; and
the fourth member comprises a fourth rotational coupling disposed proximate a first end thereof and rotationally coupled with the third member proximate a second end thereof for rotating of the fourth member with respect to the third member about a fourth axis.

3. A transforming limb according to claim 2 comprising: a fifth member rotationally coupled at a first end thereof with the first rotational coupling for rotating with respect to the first member about the first axis and having a fifth rotational coupling disposed proximate a second end thereof for rotating of the fifth member about the fifth axis.

4. A transforming limb according to claim 3 comprising: a fifth member rotationally coupled at a first end thereof with the second rotational coupling for rotating with respect to the first member about the second axis and having a sixth rotational coupling disposed proximate a second end thereof for rotating of the fifth member about the fifth axis.

5. A transforming limb according to claim 2 wherein the hub comprises a rotary actuator for in the first position of the transforming limb for controllably rotating of the first through fifth members about the fifth axis, where the approximately continuous outer surface is for forming an elliptical shape for contacting an object using a rolling motion.

6. A transforming limb according to claim 1 comprising a rotational electrical and control signal coupling disposed between the hub and the fifth member for providing of electricity to the actuators and for the control signal for controllable actuation of the first, second, third, fourth, sixth and seventh actuators.

7. A transforming limb according to claim 5 wherein the first through fourth rotational couplings each comprise an actuator for controllable actuating of the rotation between the first through fifth members.

8. A transforming limb according to claim 2 comprising: a groove assembly disposed proximate the first end of the first member; and a tongue assembly disposed about the second end of the fourth member for contacting the groove assembly when the transforming limb is in the first position.

9. A transforming limb according to claim 2 wherein the first member comprises: a first portion comprising the first end of the first member; a second portion comprising the second end of the first member; a sixth rotary coupling disposed between the first portion and the second portion of the first member, the rotational coupling for rotating of the first portion with respect to the second portion of the first member about a sixth axis.

10. A transforming limb according to claim 2 wherein the fourth member comprises: a first portion comprising the first end of the fourth member; a second portion comprising the second end of the fourth member; a seventh rotary coupling disposed between the first portion and the second portion of the fourth member, the rotational coupling for rotating of the first portion with respect to the second portion of the fourth member about the seventh axis.

11. A transforming limb according to claim 9 wherein an angle formed between the sixth axis and the second axis is approximately 90 degrees.

12. A transforming limb according to claim 10 wherein an angle formed between the seventh axis and the fourth axis is approximately 90 degrees.

13. A transforming limb according to claim 2 wherein the fifth and first axes are approximately parallel.

14. A transforming limb according to claim 2 comprising a foot coupled with the second portion of the fourth member.

15. A transforming limb according to claim 14 wherein the foot extends from the second end of the fourth member towards the first end of the fourth member past the rotary coupling formed therebetween.

16. A transforming limb according to claim 14 wherein the foot comprises a first portion and a second portion, wherein the first portion is for varying its separation with respect to the second portion in dependence upon an external force applied thereto.

17. A transforming limb according to claim 2 wherein the second, third and fourth axes are approximately parallel.

18. A transforming limb according to claim 14 wherein the foot comprises an optical sensor for sensing velocity and direction in two approximately orthogonal axes for determining speed and slippage of the foot in dependence thereon.

19. A method comprising: providing a transforming limb comprising: a first member that is rotationally coupled to a second member that is rotationally coupled to a third member that is rotationally coupled to a fourth member in series, where in a first position of the transforming limb the four members form an approximately closed shape having an approximately continuous outer surface and an inner surface of each member facing an inner surface of at least one other member from the four members, and where in a second position of the transforming limb the inside surface of at least one of the four members is for forming contact with an object and the four members form an approximately other than closed shape having the approximately continuous outer surface;
rotating the fourth member with respect to the third member;
rotating the third member with respect to the second member;
rotating the second member with respect to the first member; and,
contacting a surface with the fourth member.
